(19) United States
(12) Patent Application Publication
(10) Pub. No.: US 2025/0050610 A1
(43) Pub. Date: Feb. 13, 2025

(54) METHOD AND APPARATUS FOR WRAPPING CARDBOARD BOXES

(71) Applicant: EMMECI S.P.A., Cerreto Guidi (FI) (IT)

(72) Inventors: Pablo BARONI, Cerreto Guidi (FI) (IT); Marco MENICHETTI, Cerreto Guidi (FI) (IT); Matteo SANI, Cerreto Guidi (FI) (IT)

(73) Assignee: EMMECI S.P.A., Cerreto Guidi (FI) (IT)

(21) Appl. No.: 18/721,736

(22) PCT Filed: Dec. 7, 2022
(86) PCT No.: PCT/IB2022/061890

§ 371 Date: Jun. 19, 2024

(30) Foreign Application Priority Data
Dec. 21, 2021 (IT) 102021000031895

(51) Int. Cl. B31B 50/72; B31B 105/00; B31B 110/35

(52) U.S. Cl. CPC B31B 50/722; B31B 2105/0024; B31B 2110/35

(57) ABSTRACT

A method for wrapping a cardboard box with a wrapping sheet, includes: providing a cardboard box with a continuous edge delimiting an opening of the box; providing a wrapping sheet; coupling the box and the sheet; placing on a supporting surface the box coupled to the sheet so that the opening of the box is opposed to the supporting surface; positioning a closing system on the continuous edge of the box so as to define a closed chamber that is comprised between the box and the closing system; supplying air inside the closed chamber so as to make the box adhere to the sheet.

### FIELD OF THE INVENTION

The present invention falls within the technical field of automatic machines for manufacturing wrapped rigid boxes. More specifically, the present invention relates to an apparatus and method for wrapping a pre-formed rigid cardboard box, as well as an automated production line comprising the aforesaid apparatus and/or capable of implementing the aforesaid method.

In particular, the present invention is applied, preferably but not exclusively, to the field of automatic machines for forming cardboard boxes wrapped with a pre-glued wrapping sheet, intended for example for the luxury field, to which reference will be made hereinafter without losing generality.

### BACKGROUND

Wrapped cardboard boxes are currently manufactured on automated production lines with different stations comprising respective working machines operating in two different steps: an initial forming step, in which the box is formed from a suitably shaped and folded blank of paper or cardboard, and a subsequent wrapping step, in which a pre-glued wrapping sheet is applied to the pre-formed box so as to wrap it. The blank sheet made of paper or cardboard generally consists of a base and a plurality of flaps connected to the base and foldable thereto to form a lateral wall of the box itself, while the wrapping sheet is a flat blank sheet having a main portion shaped as the base of the blank sheet of paper or cardboard and flaps connected to the main portion and foldable to wrap the lateral walls of the pre-formed box.

An automated production line of wrapped rigid boxes typically consists of a machine for forming boxes from pre-cut blanks, a gluing device for gluing the wrapping sheets, a pointing device that receives a box formed by the forming machine and a corresponding pre-glued wrapping sheet from the gluing device and couples them by centering the base of the box on the main portion of the wrapping sheet, and a wrapping machine that receives from the pointing device a set consisting of each box coupled to its respective wrapping sheet and refines the wrapping by making the finished box available at the outlet.

In the present description as well as in the claims enclosed thereto, certain terms and expressions are deemed to have, unless otherwise expressly indicated, the meaning given in the following definitions.

The term “parallel” refers to a substantial parallelism between two elements, comprising both the ideal case in which these elements are arranged with respect to each other so as to form a null angle, and more frequent cases in which the two elements are arranged with respect to each other so as to form an angle that is not null but still negligible or irrelevant to the operation of the present solution.

The “external surface” of a wrapping sheet refers to the side of the sheet that will be visible to the user of the wrapped box. The “internal surface” of a wrapping sheet refers to the side of the sheet opposed to the one which will be visible to the user of the wrapped box.

A wrapping sheet is “pre-glued” when one of its surfaces, in particular the surface intended to be coupled to the box to be wrapped, is at least partially treated with an adhesive substance, such as glue.

The “pure rolling motion” of an object on another object refers to a kinematic condition in which the relative speed at the point of contact between the two objects is zero, in other words without the two objects slipping or sliding on each other.

Before reaching the wrapping machine, the set of box and wrapping sheet exiting the pointing device passes through a transition zone where a pressor element compresses the box from above, e.g. by setting down on the upper edges of the box or inside the box itself, on the bottom of the box or on the internal face of the box base. Thereby, thanks to the action of the pressor element, the adhesion of the wrapping sheet to the box is improved.

The Applicant noted that the use of a pressor element that sets down on the upper edges of the box to compress it from above affects the adhesion between the box and the wrapping sheet mainly at a peripheral area of the base of the box, as it does not distribute the pressure evenly over such base. As a result, undesired phenomena of partial or no adhesion of the wrapping sheet in the remaining innermost area of the base frequently occur. This drawback becomes greater as the size of the base increases, particularly in the case of boxes with a large base.

The Applicant also noted that a pressor element operating inside the box, having to compress its internal face, is subject to geometric constraints that depend on the box format, in particular on the size of the base. This solution is therefore little flexible, as it requires the pressor element mounted on the machine to be chosen according to the box format to be produced before production is started and, in the event of a format change, such a pressor element to be removed from the machine in order to choose and mount on the machine another pressor element suitable for the new format, resulting in long downtimes and a drop in productivity.

The Applicant therefore perceived that pressure on the base of the box may be exerted in an evenly distributed manner, irrespective of the size of the box, by means of a pressor element which does not have a fixed shape and volume but rather capable of suitably adapting each time to the format of the box. The Applicant has therefore realized that a gaseous pressor element is capable of exerting an even pressure on both the perimeter area and on the remaining innermost area of the box base irrespective of the specific geometric shape of the base.

The Applicant finally found that the box itself may contribute to defining the aforesaid gaseous component of the pressor element, more specifically when coupled in a substantially air-tight manner to a closing system to form a closed chamber within which a pressurized gas is supplied. Such a pressurized gas, expanding within the closed chamber, i.e. the box coupled to the closing system, operates with a constant pressure on the entire base of the box, whatever the box format being produced.

### SUMMARY

Therefore, the present invention, in a first aspect thereof, relates to a method for wrapping a box with a wrapping sheet, preferably pre-glued.

Preferably, the method comprises the step of providing a box having a base, lateral walls connected to said base and a continuous edge which is defined by said lateral walls. Preferably said box is made of cardboard or similar material. Preferably said continuous edge delimits an opening of said box. Preferably the lateral walls are connected to each other. Preferably the opening is opposed to the base.

Preferably, the method comprises the step of providing a wrapping sheet having a main portion with an internal surface and an external surface opposed to each other.

Preferably the method comprises the step of joining the internal surface of said main portion to said base of said box, preferably externally to said base of said box, to couple said box to said sheet.

Preferably, the method comprises the step of placing said box coupled to said sheet on a supporting surface so that said opening of said box is opposed to said supporting surface. Preferably said external surface of said main portion lies at least partially on said supporting surface.

Preferably, the method comprises the step of positioning a closing system on said continuous edge so as to define a closed chamber between said box and said closing system.

Preferably, the method comprises the step of supplying a gaseous substance within said closed chamber so as to make said base of said box adhere to said main portion of said sheet.

In a second aspect, the present invention relates to an apparatus for wrapping a box with a wrapping sheet.

Preferably, the apparatus comprises a main frame having a supporting surface. Preferably said supporting surface is designed to support said box coupled to said sheet at a base of said box.

Preferably the apparatus comprises at least one closing system. Preferably said closing system is arranged to face said supporting surface. Preferably, said closing system is movable with respect to the supporting surface. Preferably said closing system is configured to be positioned on a continuous edge of said box so as to define a closed chamber comprised between said box and said closing system. Preferably said continuous edge delimits an opening opposed to said supporting surface.

Preferably the apparatus comprises a pneumatic blower. Preferably, said pneumatic blower is connected to said closing system.

Preferably, said pneumatic blower is configured to supply a gaseous substance within said closed chamber.

Thanks to the present solution in which the closing system cooperates with the box to define a closed chamber, the gaseous substance supplied inside the latter tends by its very nature to occupy the entire closed chamber, i.e. the volume comprised between the box and the closing system positioned thereon. When the size of the box changes, e.g. due to a format change, the same box of the new format coupled to the closing element will define both a new closed chamber and the volume comprised between the box of the new format and the closing system positioned thereon. The present solution is therefore surprisingly flexible and suitable for any format being produced on the automatic line. Furthermore, due to the Pascal's principle according to which the pressure exerted by a liquid in a container is transmitted with the same intensity on every surface of the container in contact with the liquid regardless of its orientation, the pressure exerted by the gaseous substance inside the box is evenly distributed on the internal walls of the box, increasing as the amount of gaseous substance supplied increases. In particular, the gaseous substance exerts an even pressure on both the perimeter area and on the remaining innermost area of the base of the box, regardless of the geometric shape and size of the base, thus allowing the wrapping sheet to adhere to the entire base of the box.

The Applicant has also verified that the present solution is surprisingly able to solve the undesired phenomenon of air bubbles being trapped between the wrapping sheet and the external face of the box base, particularly when the formed box is centered and adhered with the external face of its base to the main portion of the pre-glued sheet. Such phenomenon, which is particularly evident in the case of large boxes, has the twofold disadvantage of being unpleasant and of compromising the strength of the wrapping, and is therefore partially counteracted by one or more operators who attempt to promptly operate on the box exiting the production line, manually stretching and smoothing the wrapping sheet to disperse bubbles before the glue acts and adhesion is final. In accordance with the present solution, the even pressure exerted by the gaseous substance on the base of the box ensures that any air bubbles formed between the wrapping sheet and the external surface of the base of the box are pushed towards the perimeter area of the base and escape easily from there, particularly in a step wherein the glue has not yet acted firmly and adhesion is not final, without getting stuck in such perimeter area, for example due to an increased pressure exerted thereon.

In at least one of the aforesaid aspects, the present invention may further have at least one of the preferred characteristics set forth hereinafter.

In one or more embodiments, the supporting surface is movable, in particular operable to move said box coupled to said sheet in a feeding direction, the method preferably comprising operating said supporting surface to move the box coupled to the sheet in a feeding direction.

Thanks to the possibility of entrusting the supporting surface with the movement of the objects lying on it, the box coupled to the sheet may pass from the pointing device to the wrapping machine with no need for manual intervention by an operator physically grasping the box, thus avoiding the risk of ruining the box and/or the wrapping sheet due to an inaccurate or vigorous or, on the contrary, weak grip by the operator.

In one or more embodiments, the closing system is movable in a movement direction that is parallel to said feeding direction. Preferably said moving said box coupled to said sheet is carried out at least partially while the closing system is positioned on said continuous edge, preferably while said gaseous substance is supplied within said box.

In this way, defining the closed chamber and the pressure of the gaseous substance inside the box can take place simultaneously with the movement of the box coupled to the sheet, in particular from the pointing device to the wrapping machine, without having to stop the movement of the box and thus reducing the production time, i.e. increasing the production volume of the automatic line.

In one or more embodiments, the method comprises operating at least partially on said external surface of said sheet by means of smoothing means in contrast to said closing system, in particular when said closing system is positioned on said continuous edge of said box.

In one or more embodiments said operating by means of smoothing means includes reciprocally moving said smoothing means and said box coupled to said sheet in a direction parallel to said main portion of said sheet.

Thanks to the action of the smoothing means in contrast to the closing system positioned on the continuous edge of the box, a force is exerted on the external surface of the sheet coupled to the box that has a component perpendicular to the external surface of the sheet and, preferably, a component parallel to such external surface. The sheet is thereby automatically stretched and smoothed by the smoothing means, improving the adhesion of the sheet to the base of the box as well as the aesthetic appearance of the final box, further forcing the dispersion of any residual air bubbles, particularly at the step wherein the glue has not yet acted firmly and adhesion is not final.

In one or more embodiments, said operating by means of smoothing means comprises rotating at least one roller on said external surface of said sheet. Preferably said rotating at least one roller includes operating said at least one roller with a pure rolling motion on said external surface of said sheet.

Thanks to the pure rolling motion, i.e. without the roller slipping or sliding on the external surface of the sheet, scratches, abrasions or wear that could be caused by a roller that is not perfectly smooth, are avoided on the latter.

In one or more embodiments, said operating by means of smoothing means comprises supplying at least one air blade.

In one or more embodiments, said operating by means of smoothing means comprises moving said box coupled to said sheet in such a way that an elongated element, preferably fixed with respect to said supporting surface, for example a rod placed under the supporting surface and in contact therewith, in particular transverse to the feeding direction of the box coupled to the sheet, operates on said external surface of said sheet.

In one or more embodiments, the method comprises adjusting a distance of said smoothing means from said supporting surface. It is thereby possible to adjust the force, i.e. the pressure exerted by the smoothing means on the external surface of said sheet.

In one or more embodiments, said gaseous substance comprises an odorous substance, preferably a customizable one. The finished box thereby acquires a characteristic fragrance, which in particular identifies the product contained in the box itself or the manufacturing company, enabling the purchaser to recognize—not only visually—the quality and worth of the product purchased.

In one or more embodiments, said gaseous substance is supplied with a pressure comprised between 0.3 Bar and 4 Bars, preferably between 0.5 Bar and 4 Bars. Preferably, said gaseous substance is supplied with a pressure between 0.7 Bar and 1.5 Bars. Preferably, said gaseous substance is supplied at a pressure of 1 Bar.

In one or more embodiments, said gaseous substance is applied with a variable pressure. Preferably, said pressure is increasing. Equally preferably, said pressure is decreasing. Equally preferably, said pressure has a periodic trend over time. It is thereby possible to control the pressure inside the closed chamber and prevent a too high instantaneous pressure of the gaseous substance from deforming the box, or control that a too low and therefore ineffective pressure is gradually increasing to a suitable level, e.g. depending on the strength of the box.

In one or more embodiments, said gaseous substance is supplied in a time interval with a duration between 0.5 s and 3 s. Preferably said time interval has a duration between 0.7 s and 1.5 s. Preferably said time interval has a duration of 1 s. The possibility of varying the duration of the time interval during which the gaseous substance is supplied makes it possible to take into account the format of the box, i.e. the speed of production.

In one or more embodiments, the method comprises controlling a position of said closing system as a function of at least one physical magnitude between a distance of said closing system from said supporting surface, a distance of said closing system from said continuous edge, a pressure exerted by said closing system on said continuous edge. By controlling the distance of said closing system from said supporting surface and/or said continuous edge, the movement closer of the closing system may be suitably controlled to optimize the time required to position the closing system on said continuous edge and, furthermore, to avoid possible crushing of the box. By controlling the pressure of the closing system on the continuous edge, the force exerted on the latter and on the lateral walls of the box may be suitably adjusted so as to control the effectiveness of the system and, at the same time, prevent an excessive pressure from damaging the box or hindering any air bubbles trapped between the wrapping sheet and the external face of the box base from being pushed towards the perimeter area of the base and from escaping easily therefrom.

In one or more embodiments, the method comprises controlling a position of said closing system according to a speed difference between said closing system and said supporting surface. The closing system and the box coupled to the sheet and moved by the supporting surface may thereby be moved with almost identical speed, particularly when the closing system is positioned on the continuous edge of the box. This prevents a speed difference between said closing system and said box coupled to the sheet, either positively or negatively, from deforming and damaging the box.

In one embodiment the wrapping sheet comprises one or more flaps connected to the main portion and foldable thereto, the method preferably comprising folding said flaps to at least partially wrap the lateral walls of the box.

In one or more embodiments, said closing system comprises a carrier assembly movable in a movement direction, preferably parallel to said feeding direction. In one or more embodiments, said closing system comprises a flat main element designed to be positioned and abut said continuous edge of said box. Preferably, said main element is connected to said carrier assembly and is limitedly movable relatively to the latter in said movement direction. The movement of the closing system in the movement direction is entrusted to the carrier assembly. Due to the limited mobility of the main element in relation to the carrier assembly of the closing system, when the main element is positioned to abut against the continuous edge of the box, even small differences in speed between said closing system and said box, coupled to the sheet and moved by the supporting surface, may be compensated for.

Preferably, said carrier assembly includes a central element. Preferably, said carrier assembly includes a secondary element. Preferably the secondary element is flat, preferably substantially parallel to said main element. Preferably the secondary element has a feedthrough opening. Preferably said central element is inserted with play through said feedthrough opening. Preferably said central element is rigidly connected to said main element. Preferably said secondary element is connected to said main element in a limitedly movable manner in said movement direction. Preferably said secondary element is connected to said central element in a limitedly movable manner in said movement direction.

In one or more embodiments, said closing system comprises a protecting element made of elastic material. Preferably said protecting element faces said supporting surface and is intended to be positioned on said continuous edge of said box. Preferably said elastic material of said protecting element has a hardness between Shore A 25 and Shore A 85, preferably between Shore A 35 and Shore A 65. In particular, said elastic material is one of latex, hard rubber, soft rubber. Preferably said elastic material is a synthetic rubber, preferably an EPDM (Ethylene-Propylene Diene Monomer) rubber. Preferably said elastic material is one of a closed-cell and a semi-closed-cell foam material.

The protecting element made of elastic material allows to dampen the impact between the closing system and the edge of the box and reduces any deformation of the lateral walls. The choice of a suitable hardness of the plastic material makes it possible to create a protecting element capable of quickly regaining its shape when passing from one box to another, and with the right porosity to retain the gaseous substance, which must not penetrate the protecting element itself and disperse outside the closed chamber, reducing the pressure inside the latter.

In one or more embodiments, the apparatus comprises a drive unit connected to said closing system to move the latter relatively to said supporting surface.

In one or more embodiments, the apparatus comprises a control unit connected to said closing system and designed to control a position of said closing system.

In one or more embodiments, the apparatus comprises smoothing means connected to said supporting surface to operate at least partially on said sheet coupled to said box, preferably in contrast to said closing system. Preferably, said smoothing means are movable relatively to the supporting surface. In one or more embodiments, said smoothing means are movable closer to and away from the supporting surface. In one or embodiments, said smoothing means are movable to brush said supporting surface.

In one or more embodiments, said smoothing means are positioned between said supporting surface and said closing system. In one or more embodiments, said supporting surface is positioned between said smoothing means and said closing system.

In one or more embodiments, said smoothing means comprise at least one of a roller and an air blade.

In one or more embodiments, said smoothing means are removable.

In one or more embodiments, said pneumatic blower is directed towards the supporting surface, so as to supply the gaseous substance and exert pressure mainly on the internal surface of the box. In one or more embodiments, said pneumatic blower is facing the direction opposed to said supporting surface, so as to supply the gaseous substance and any undesirable substances away from the box, in particular on the internal surface of the closing element, so as not to contaminate or soil the box itself.

In one or more embodiments, the apparatus comprises two closing systems with the above-mentioned characteristics. Preferably, said closing systems are intended to operate alternately, each on one box of a sequence of boxes. Preferably, said closing systems are intended to operate simultaneously, each on one box of a sequence of boxes.

It should be specified that some steps of the method described above may be independent of the order of execution given, except where a sequentiality or simultaneity between two or more steps is expressly indicated as necessary. In addition, some steps may be optional. Furthermore, some steps may be performed repetitively, or they may be carried out in series or in parallel with other steps of the method.

### BRIEF DESCRIPTION OF THE DRAWINGS

The features and advantages of the invention will better appear from the following detailed description of a preferred embodiment, shown merely for exemplary and non-limiting purposes with reference to the accompanying drawings, in which:

FIG. 1 is a perspective view, from above, of a box and a wrapping sheet

FIG. 2 is a perspective view, from above, of a part of an apparatus for wrapping a box with a wrapping sheet according to the present invention;

FIG. 3 is an enlarged view of the part of an apparatus of FIG. 2;

FIG. 4 is a perspective view, from above, of a system belonging to the apparatus according to the present invention.

### DETAILED DESCRIPTION OF THE PREFERRED EMBODIMENTS

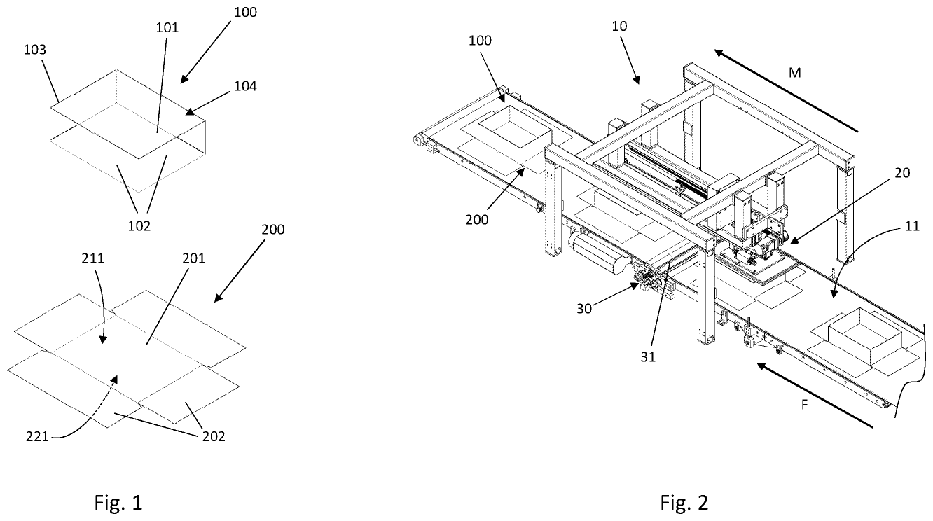

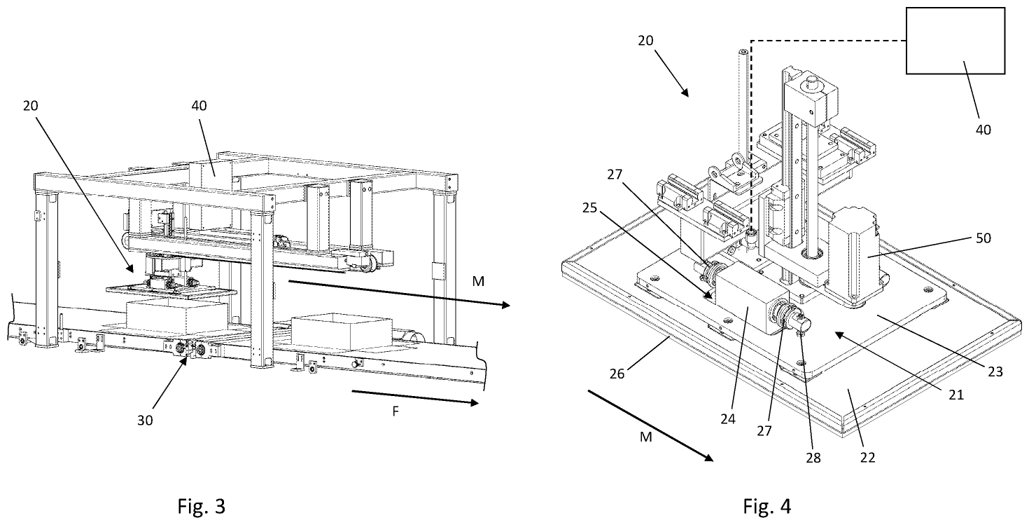

In FIG. 1 a box 100, e.g. made of cardboard, having a rectangular base 101 and four lateral walls 102 is shown. The lateral walls 102 are both connected to the base 101 and connected to each other in such a way as to define a continuous edge 103 delimiting an opening 104 of the box 100. The opening 104 is thus opposed to the base 101.

In FIG. 1 a wrapping sheet 200 with a main portion 201 having an internal surface 211 and an external surface 221 opposite to each other is also shown. The sheet 201 also comprises four flaps 202 connected to the main portion 201 and foldable thereto.

An automated line for producing wrapped rigid boxes comprises at least one apparatus for wrapping the carton box 100 with the wrapping sheet 200.

The apparatus comprises a main frame 10 with a supporting surface 11 which may be moved, a closing system 20 arranged facing the supporting surface 11 and movable with respect thereto, and a pneumatic blower 40 connected to the closing system 20 and configured to supply a gaseous substance, such as air.

Referring to FIG. 4, the closing system 20 comprises a carrier assembly 21 movable in a movement direction M and a flat main element 22, such as a plate. The carrier assembly 21 includes a central element 24 and a flat secondary element 23, such as a slab substantially parallel to the plate 22 and provided with a feedthrough opening 25. The central element 24 is inserted with play through the feedthrough opening 25 of the slab 23 and rigidly connected to the plate 22. The slab 23 is connected to the plate 22 in a limitedly movable manner in the movement direction M, e.g. by means of balls or cylinders housed in appropriate seats of the slab 23 and corresponding suitable seats of the plate 22. The slab 23 is also connected to the central element 24 in a limitedly movable manner in the movement direction M, for example by means of an elastic system comprising a pair of springs 27 capable of compressing and extending in the movement direction M; in particular, each spring 27 has one end fixed to the central element 24 and the other end connected to the slab 23 by means of a respective pin 28.

The closing system 20 also comprises a protecting element 26, for example a layer of elastic material, in particular latex, coupled to the plate 22 so that it faces the supporting surface 11.

A drive unit 50 for moving the closing system 20 relative to the supporting surface 11, and a control unit for controlling a position of the closing system 20 are connected to the closing system.

The apparatus also comprises smoothing means 30 which comprise a roller 31 connected to the supporting surface, in particular housed in a recess of the supporting surface 11 so as to be positioned between said supporting surface 11 and the closing system 20. The roller 31 may be either idle or driven to rotate. The roller 31 is also linearly movable with respect to the supporting surface 11, for example to adjust a distance of the roller 31 itself from the supporting surface 11, i.e. a height of the roller 31 in the apparatus, or to move the roller 31 in a direction substantially parallel to the movement direction M.

In the apparatus in operation, the box 100 exiting a forming machine, not shown, is coupled to the wrapping sheet 200 which has been pre-glued by a gluing device, also not shown, in particular by joining the internal surface 211 of the main portion 201 of the sheet 200 to the base 101 of the box 100.

The set of box 100 and sheet 200 is then placed on the supporting surface 11, so that the external surface 221 of the sheet 200 lies on the supporting surface 11 and the opening 104 is opposed to the latter.

The supporting surface 11 is driven to move the box 100 coupled to the sheet 200 in a feeding direction F towards a wrapping machine, not shown in the Figure. The movement direction M is parallel to the feeding direction F.

In the transition zone, the box 100 coupled to the sheet 200 is stopped at an appropriate distance from the roller 31 and from the recess in which it is housed.

The plate 22 of the closing system 20 is then operated by the drive unit 50 moving closer, jointly with the protecting element 26 coupled thereto, to the supporting surface. The control unit controls the position of the closing system 20, e.g. according to the distance of the closing system 20 from the supporting surface or the continuous edge 103 of the box, in order to properly position it on the continuous edge 103 of the box. Thanks also to the elasticity of the protecting element 26, the closing system 20 is entirely coupled to the continuous edge 103, so as to define a closed chamber comprised between the box 100 and the closing system 20.

The control unit continues to control the position of the closing system 20, e.g. according to the pressure exerted by the closing system 20 on the continuous edge 103, in order to prevent the box 100 from being damaged.

At this stage the supporting surface 11 is again actuated to move the box 100 coupled to the sheet 200 in the feeding direction F, towards the roller 31, and the drive unit 50 actuates the closing system 20 to move it in the movement direction M parallel to the feeding direction F. In this step, the control unit controls the position of the closing system 20, in particular according to a difference in speed between said closing system 20 and said supporting surface 11, so that the closing system 20 and the box 100 move substantially as one. As already noted, any small differences in speed may however be compensated for by the limited mobility between the carrier assembly 21 and the main element 22 of the closing system 20.

While the closing system 20 is positioned on the continuous edge 103 the pneumatic blower 40 supplies air into the closed chamber, e.g. for a time interval of 0.5 seconds. Air may be supplied with an increasing pressure from 0.5 Bar to 1 Bar, for example, after a short initial transient of the pneumatic blower 40. The air supplied within the closed chamber spontaneously occupies the entire closed chamber and exerts an even pressure on the base 101 and the lateral walls 102 of the box 100, which define the closed chamber itself together with the closing system 20. The base 101 of the box 100 is entirely subjected to an even force that makes it adhere to the main portion 201 of the wrapping sheet 200.

While proceeding in the feeding direction F, the box 100 coupled to the sheet 200 reaches the roller 31. The latter rotates with a pure rolling motion on the external surface 221 of the sheet 200 while the box 100 coupled to the sheet 200 continues to move towards the wrapping machine. The roller 31 thereby operates on the external surface 221 of the sheet 200 in contrast to the closing system 20 positioned on the continuous edge 103 of the box 100, stretching and smoothing the main portion 201 of the wrapping sheet 200 on the base 101 of the box 100 so as to improve the adhesion between the sheet 200 and the box 100 and giving it a neat and elegant appearance.

Proceeding further in the feeding direction F, the box 100 coupled to the sheet 200 overcomes the roller 31 and the recess in which it is housed. At this stage, the drive unit 50 drives the closing system 20 moving away from the supporting surface and the control unit controls the position of the closing system 20, e.g. according to the distance of the closing system 20 from the supporting surface or the continuous edge 103 of the box. The box 100 coupled to the sheet 200 may then freely proceed towards the wrapping machine.

1. Method for wrapping a box with a wrapping sheet, the method comprising:
providing a cardboard box (100) having a base (101), lateral walls (102) connected to said base (101) and a continuous edge (103) which is defined by said lateral walls (102) and delimits an opening (104) of said box (100);
providing a wrapping sheet (200) having a main portion (201) with an internal surface (211) and an external surface (221) opposed to each other;
joining said internal surface (211) of said main portion (201) to said base (101) of said box (100), to couple said box (100) to said sheet (200);
placing said box (100) coupled to said sheet (200) on a supporting surface (11) so that said opening (104) of said box (100) is opposed to said supporting surface (11);
positioning a closing system (20) on said continuous edge (103) to define a closed chamber that is comprised between said box (100) and said closing system (20);
supplying a gaseous material inside said closed chamber so that said base (101) of said box (100) adheres to said main portion (201) of said sheet (200).

2. The method according to claim 1, wherein said supporting surface (11) is movable, the method further comprising operating said supporting surface (11) to move said box (100) coupled to said sheet (200) in a feeding direction (F).

3. The method according to claim 2, wherein said closing system (20) is movable in a movement direction (M) parallel to said feeding direction (F), and said moving said box (100) coupled to said sheet (200) is carried out at least partially while said closing system (20) is positioned on said continuous edge (103) and said gaseous material is supplied inside said box (100).

4. The method according to claim 1, further comprising operating at least partially on said external surface (221) of said sheet (200) by means of smoothing means (30) in contrast to said closing system (20), when said closing system (20) is positioned on said continuous edge (103) of said box (100).

5. The method according to claim 4, wherein said operating by means of smoothing means (30) comprises reciprocally moving said smoothing means (30) and said box (100) coupled to said sheet (200) in a direction parallel to said main portion (201) of said sheet (200).

6. The method according to claim 4, wherein said operating by means of smoothing means (30) comprises rotating at least one roller (31, 32) on said external surface (221) of said sheet (200).

7. The method according to claim 6, wherein said rotating at least one roller (31, 32) includes operating said at least one roller (31, 32) with a pure rolling motion on said external surface (221) of said sheet (200).

8. The method according to claim 4, wherein said operating by means of smoothing means (30) comprises supplying at least one air blade.

9. The method according to claim 4, further comprising adjusting a distance of said smoothing means (30) from said supporting surface (11).

10. The method according to claim 1, wherein said gaseous material comprises an odorous substance.

11. The method according to claim 1, further comprising controlling a position of said closing system (20) as a function of at least one quantity among a distance of said closing system (20) from said supporting surface (11), a distance of said closing system (20) from said continuous edge (103), a pressure applied by said closing system (20) on said continuous edge (103), a difference in speed between said closing system (20) and said supporting surface (11).

12. Apparatus for wrapping a cardboard box (100) with a wrapping sheet (200), the apparatus comprising:
a main frame (10) having a supporting surface (11) configured to support said box (100) coupled to said sheet (200) at a base (101) of said box (100);
at least one closing system (20), arranged to face said supporting surface (11), movable relative to said supporting surface (11) and configured for positioning on a continuous edge (103) of said box (100) delimiting an opening (104) opposed to said supporting surface (11), in order to define a closed chamber comprised between said box (100) and said closing system (20);
a pneumatic blower (40), connected to said closing system (20) and configured to supply a gaseous material inside said closed chamber.

13. The apparatus according to claim 12, wherein said supporting surface (11) is operable to move said box (100) coupled to said sheet (200) in a feeding direction (F), and wherein said closing system (20) comprises a carrier assembly (21) movable in a movement direction (M) parallel to said feeding direction (F), and a main element (22), flat, designed to be positioned and abut said continuous edge (103) of said box (100), said main element (22) being connected to said carrier assembly (21) and limitedly movable with respect to the latter in said movement direction (M).

14. The apparatus according to claim 13, wherein said carrier assembly (21) includes a central element (24) and a secondary element (23) that is flat and substantially parallel to said main element (22) and has a feedthrough opening (25), said central element (24) being inserted through said feedthrough opening (25) with play and rigidly connected to said main element (22), said secondary element (23) being connected to said main element (22) and central element (24) to be movable in a limited manner in said movement direction (M).

15. The apparatus according to claim 12, wherein said closing system (20) comprises a protecting element (26) in elastic material, facing said supporting surface (11) and is configured to be positioned on said continuous edge (103) of said box (100).

16. The apparatus according to claim 12, further comprising a drive unit (50) connected to said closing system (20) for moving said closing system with respect to said supporting surface (11).

17. The apparatus according to claim 12, further comprising a control unit connected to said closing system (20) and designed to control a position of said closing system (20).

18. The apparatus according to claim 12, further comprising smoothing means (30) connected to said supporting surface (11) to operate at least partially on said sheet (200) coupled to said box (100), in contrast to said closing system (20).

19. The apparatus according to claim 18, wherein said smoothing means (30) is movable relative to said supporting surface (11).

20. The apparatus according to claim 18, wherein said smoothing means (30) is positioned between said supporting surface (11) and said closing system (20).

21. The apparatus according to claim 18, wherein said smoothing means (30) comprises at least one of a roller (31, 32) or an air blade.
